(19) United States
(12) Patent Application Publication
(10) Pub. No.: US 2010/0241985 A1
(43) Pub. Date: Sep. 23, 2010

(54) Providing Virtual Keyboard

(75) Inventors: Seung Beom Kim, Seoul (KR); Jong Woong Lee, Seoul (KR)

Correspondence Address: FISH & RICHARDSON, PC, P.O. BOX 1022, MINNEAPOLIS, MN, 55440-1022, US

(73) Assignee: CORE LOGIC, INC., Seoul (KR)

(21) Appl. No.: 12/729,002

(22) Filed: Mar. 22, 2010

(30) Foreign Application Priority Data
Mar. 23, 2009 (KR) 1020090024677
Dec. 2, 2009 (KR) 1020090118534

(51) Int. Cl. G06F 3/048

(52) U.S. Cl. 715/773

(57) ABSTRACT

Apparatus and methods are described for providing a virtual keyboard. In one aspect, an apparatus for providing a virtual keyboard to be displayed on a touch screen is described. The apparatus includes a memory unit that includes a data repository to store data comprising at least one virtual keyboard configuration information to configure at least one corresponding virtual keyboard. The apparatus includes a processing module to select from the data stored in the data repository a given virtual keyboard configuration information to select a corresponding virtual keyboard to configure; configure the selected virtual keyboard to have a fan-like shape with multiple keys of the virtual keyboard arranged along an outline of an arc in a fan-shaped region based on the selected virtual keyboard configuration information; and instruct a touch screen module to display the configured virtual keyboard on a display region of a touch screen.

### CLAIM OF PRIORITY

This application claims the benefit of Korean Patent Application No. 10-2009-0024677, filed on Mar. 23, 2009, and Korean Patent Application No. 10-2009-0118534, filed on Dec. 2, 2009, in the Korean Intellectual Property Office, the contents of which are incorporated herein in their entirety by reference.

### BACKGROUND

The present disclosure relates to an apparatus and method for providing a virtual keyboard, and more particularly, to virtual keyboard-related technology for providing various forms of virtual keyboards which are configured to facilitate the input of information and are optimized for a user.

With the recent development of digital technology, the use of portable terminals is becoming popular, and a variety of services are being developed for the portable terminals. The portable terminal can refer to a small-sized and light-weight device which is configured to be carried by a user. A conventional portable terminal can be equipped with various functions similar to those found in a Personal Computer (PC), such as communication, game, and multimedia functions.

Typically, a portable terminal can be equipped with user input means for receiving information from a user. For example, a portable terminal can include a number of input keys.

### SUMMARY

Techniques, systems, apparatus and computer-readable storage media are described to provide a virtual keyboard configured to facilitate the entry of keys and provide various forms of virtual keyboards according to the needs of a user.

In one aspect, an apparatus for providing a virtual keyboard to be displayed on a touch screen is described. The apparatus includes a memory unit that includes a data repository to store data including at least one virtual keyboard configuration information to configure at least one corresponding virtual keyboard. The apparatus includes a processing module to select from the data stored in the data repository a given virtual keyboard configuration information to select a corresponding virtual keyboard to configure; configure the selected virtual keyboard to have a fan-like shape with multiple keys of the virtual keyboard arranged along an outline of an arc in a fan-shaped region based on the selected virtual keyboard configuration information; and instruct a touch screen module to display the configured virtual keyboard on a display region of a touch screen.

Implementations can optionally include one or more of the following features. The at least one virtual keyboard configuration information can include an indication of at least the following: a position of the selected virtual keyboard on a display region of the touch screen; a portion of the display region of the touch screen occupied by the selected virtual keyboard; positions of the keys within the selected virtual keyboard; and values associated with the keys, wherein the values are assigned based on an input mode. The at least one virtual keyboard can include at least one of: a first virtual keyboard in which multiple keys are arranged along an outline of an arc in a fan-shaped region with a lower right portion of the display region of the touch screen being a central point of the arc; a second virtual keyboard in which multiple keys are arranged along an outline of an arc in a fan-shaped region with a lower left portion of the display region of the touch screen being a central point of the arc; a third virtual keyboard in which multiple keys are arranged along an outline of an arc in a fan-shaped region with an upper right portion of the display region of the touch screen being a central point of the arc; or a fourth virtual keyboard in which multiple keys are arranged along an outline of an arc in a fan-shaped region with an upper left portion of the display region of the touch screen being a central point of the arc.

Implementations can optionally include one or more of the following features. Responsive to receiving, from the touch screen module, a signal indicating a user input for selecting another virtual keyboard, the virtual keyboard processing module can select from the data stored in the data repository another virtual keyboard configuration information to select another virtual keyboard to configure and can instruct the touch screen module to display the selected other virtual keyboard on the display region of the touch screen based on the selected other virtual keyboard configuration information. Responsive to receiving, from the touch screen module, a signal indicating a user input to move the selected virtual keyboard to a different position on the display region of the touch screen, the virtual keyboard processing module can be operable to move the selected virtual keyboard to the different position corresponding to the user input. The virtual keyboard processing module can be operable to, in real time: analyze and process the signal indicating user input to move the selected virtual keyboard to a different position on the display region of the touch screen; and instruct the touch screen module to display in real time the selected virtual keyboard moving on the display region of the touch screen during the user input.

Implementations can optionally include one or more of the following features. Responsive to receiving, from the touch screen, a signal indicating a user input for switching an input mode, the virtual keyboard processing module can be operable to switch a given input mode to another input mode based on the received signal indicating the user input for switching the input mode. The apparatus can include a virtual keyboard size setting module operable to: provide a user interface for setting a size of the selected virtual keyboard through the display region of the touch screen; and set a size of the selected virtual keyboard based on information received through the user interface. The virtual keyboard size setting module can receive coordinates of a point on the display region of the touch screen selected by a user through the user interface. The virtual keyboard size setting module can set the fan-shaped region of the selected virtual keyboard having a radius from a central point of the selected virtual keyboard to the received coordinates of the point as the size information. The virtual keyboard processing module can be operable to instruct the touch screen module to display the user interface to include information instructing the user to make a dragging motion across a desired region on the display region of the touch screen. The virtual keyboard processing module can be operable to receive the size information from the virtual keyboard size setting module; modify the selected virtual keyboard configuration information based on the received size information; and instruct the touch screen module to display the selected virtual keyboard having a size adjusted based on the modified virtual keyboard configuration information on the display region of the touch screen. The virtual keyboard processing module can be operable to modify the portion of the display region of the touch screen occupied by the selected virtual keyboard based on the received size information; calculate new positions of the keys based on the modified portion of the display region of the touch screen occupied by the selected virtual keyboard; and modify the positions of the keys based on the calculated new positions of the keys.

In another aspect, a method of providing a virtual keyboard performed by a virtual keyboard providing apparatus operating in conjunction with a touch screen module can include: selecting a virtual keyboard configuration information to select a corresponding virtual keyboard from data stored in a data repository of a memory unit; and instructing the touch screen module to display the selected virtual keyboard having a fan-shape in which multiple keys are arranged along an outline of an arc in a fan-shaped region based on the selected virtual keyboard configuration information.

Implementations can optionally include one or more of the following features. The method can include receiving, from the touch screen module, a signal indicating a user input on the display region of the touch screen for selecting another virtual keyboard; selecting, from the touch screen module, another virtual keyboard configuration information for configuring another virtual keyboard from the database; and instructing the touch screen module to display the other virtual keyboard on the display region of the touch screen based on the selected another virtual keyboard configuration information. The method can include receiving, from the touch screen module, a signal indicative of a user input; and moving the selected virtual keyboard to a different position corresponding to the user input on the display region of the touch screen. The method can include receiving a signal indicative of a user action for switching an input mode from the touch screen module; and switching a given input mode to another input mode corresponding to the received information signal. The method can include providing a user interface for setting a size of the virtual keyboard on the display region of the touch screen; and setting a size of the selected virtual keyboard based on information received through the user interface. The method can include modifying the selected virtual keyboard configuration information based on the set size information; and displaying the selected virtual keyboard having a size adjusted based on the modified virtual keyboard configuration information on the display region of the touch screen. The method can include modifying the virtual keyboard configuration information based on the set size information comprising: modifying the portion of the display region of the touch screen occupied by the virtual keyboard based on the set size information; calculating positions of the keys based on the modified portion of the display region of the touch screen; and modifying the positions of the keys based on the calculated positions.

The described techniques, apparatus and systems can provide one or more of the following advantages. Using the described techniques, apparatus, systems and computer-readable storage media, various forms of virtual keyboards that enable ease of use can be provided. Further, the shape, the position, and the input mode of a virtual keyboard can be easily selected and switched through a simple interaction (for example, a touch or a drag) with a touch screen interface. In addition, a virtual keyboard optimized for a user can be provided because the user can control the size of the virtual keyboard according to a desired size.

### BRIEF DESCRIPTION OF DRAWINGS

FIG. 1 is an exemplary diagram showing a known virtual keyboard provided in a portable terminal.

FIG. 2 is an exemplary diagram showing a typical action of a user inputting information by touching keys displayed on the touch screen of the portable terminal.

FIG. 3 is a block diagram showing the configuration of a portable terminal equipped with an apparatus for providing various types of virtual keyboards according to a specific embodiment of the present disclosure.

FIG. 4 is a block diagram showing the configuration of the virtual keyboard providing apparatus according to a specific embodiment of the present disclosure.

FIG. 5 is an exemplary diagram showing a first virtual keyboard which is one of various types of the virtual keyboards provided by the virtual keyboard providing apparatus according to a specific embodiment of the present disclosure.

FIG. 6 is an exemplary diagram showing a second virtual keyboard which is another of various types of the virtual keyboards provided by the virtual keyboard providing apparatus according to a specific embodiment of the present disclosure.

FIG. 7 is an exemplary diagram showing a third virtual keyboard which is yet another of various types of the virtual keyboards provided by the virtual keyboard providing apparatus according to a specific embodiment of the present disclosure.

FIG. 8 is an exemplary diagram showing a fourth virtual keyboard which is further yet another of various types of the virtual keyboards provided by the virtual keyboard providing apparatus according to a specific embodiment of the present disclosure.

FIG. 9 is an exemplary diagram illustrating a virtual keyboard selection action for selecting virtual keyboards in the screen of a touch screen.

FIG. 10 is an exemplary diagram illustrating a virtual keyboard movement action and an example in which a virtual keyboard is moved according to the virtual keyboard movement action.

FIG. 11 is an exemplary diagram illustrating another virtual keyboard provided by the virtual keyboard providing apparatus.

FIG. 12 is an exemplary diagram illustrating an input mode switch action for switching the input mode of a virtual keyboard.

FIG. 13 is an exemplary diagram showing a size setting user interface which is displayed in the screen of the touch screen by a virtual keyboard size setting module.

FIG. 14 is an exemplary diagram showing a virtual keyboard having a size adjusted by a virtual keyboard processing module.

FIG. 15 is an exemplary diagram showing another size setting user interface which is displayed in the screen of the touch screen by the virtual keyboard size setting module.

FIG. 16 is an exemplary diagram showing a virtual keyboard having a size adjusted by a virtual keyboard processing module.

FIG. 17 is a flowchart illustrating a procedure of providing a virtual keyboard, which is performed by the virtual keyboard providing apparatus.

FIG. 18 is a flowchart illustrating a procedure of adjusting the size of a virtual keyboard, which is performed by the virtual keyboard providing apparatus.

### DETAILED DESCRIPTION

Unlike a stationary terminal, such as a PC, a portable terminal tends to have a small footprint, which can make it a challenge to effectively dispose a keyboard on the portable terminal. Further, repeated use of the keyboard on the portable terminal can lead to frequent breakage.

A virtual keyboard can be implemented as a substitute for a physical keyboard on a portable terminal. For example, a virtual keyboard can be displayed on a display region of a touch screen, and actuation of a given key in the virtual keyboard can trigger a key value corresponding to the actuated key.

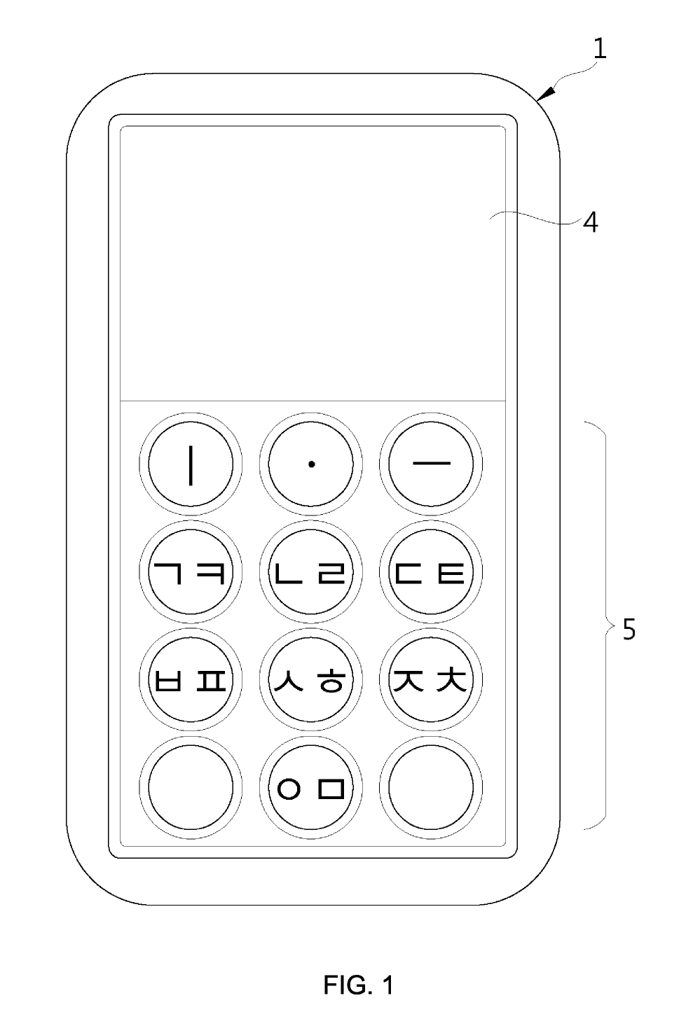

FIG. 1 is an exemplary diagram showing a conventional virtual keyboard provided in a portable terminal. The virtual keyboard 5 is displayed in a square-shaped display region of a touch screen 4 provided in the portable terminal 1. A portion or the entire display region of the touch screen can be dedicated to displaying the virtual keyboard 5. The virtual keyboard 5 includes a number of keys corresponding to characters, numbers, and special characters. The keys are arranged within the square region at specific intervals in horizontal and vertical directions to form a matrix-like arrangement. Additionally, a virtual keyboard of a matrix form can be used to arrange the keys in landscape or portrait format to allow the user to operate the portable terminal in landscape or portrait view.

The keys included in the conventional virtual keyboard 5 may include keys that are difficult to reach by the user, especially in one-handed operation. This may be because the conventional virtual keyboard 5 is displayed on the display region of the touch screen 4 in a simple form (for example, a square shape) that may not take into consideration a range of motion of a user's hand and fingers.

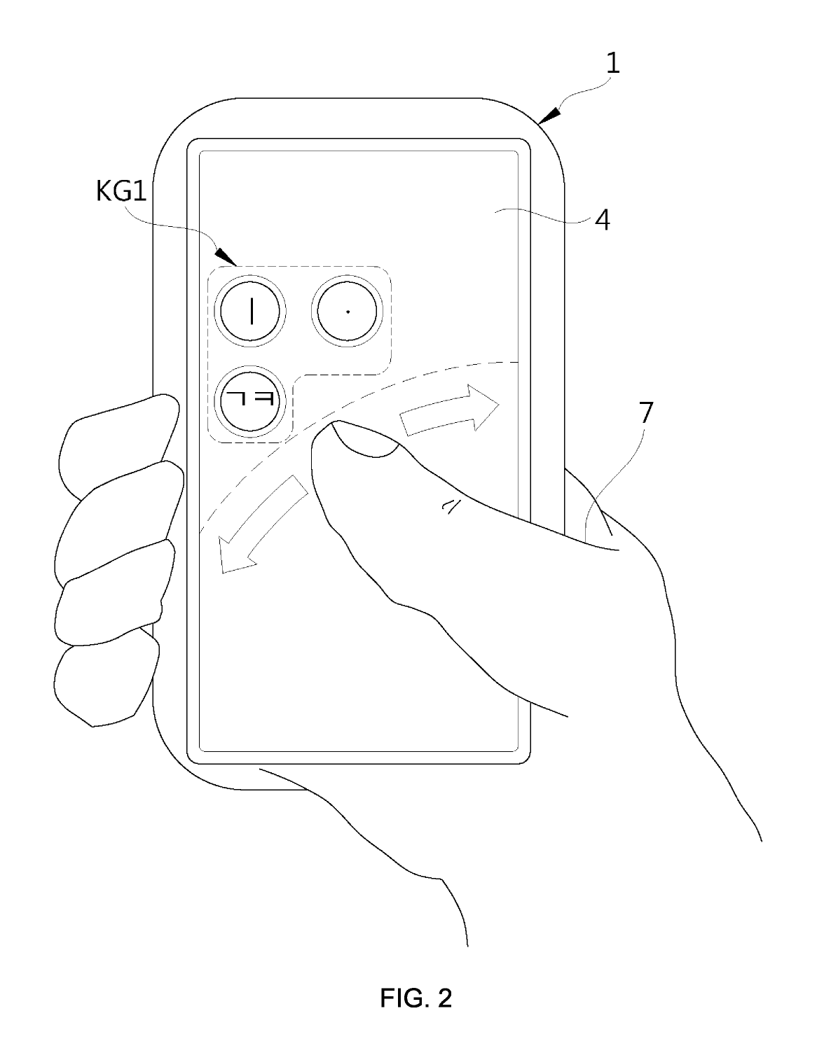

FIG. 2 is an exemplary diagram showing a range of motion of a user inputting information by touching keys displayed on the display region of the touch screen 4 of the portable terminal 1. Referring to FIGS. 1 and 2, typically, a user may select and touch a desired key from the keys displayed in the touch screen 4 by moving his fingers or the thumb 7 while holding the portable terminal 1 in one hand. As shown in FIG. 2, a range of movement for the user's thumb 7 can be described to cover a fan- or arc-shaped region.

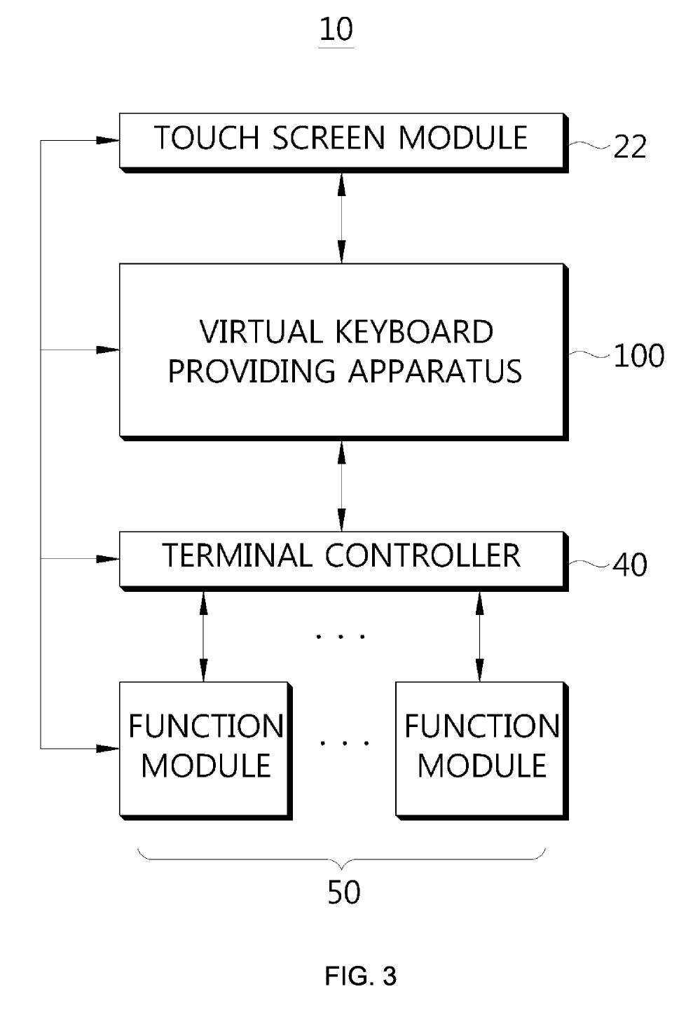

FIG. 3 is a block diagram showing an exemplary configuration of a portable terminal equipped to provide a virtual keyboard according to an embodiment of the present disclosure. The portable terminal 10 can include a touch screen module 22, a virtual keyboard providing apparatus 100, a terminal controller 40, and a number of function modules 50.

The touch screen module 22 displays information received from the virtual keyboard providing apparatus 100, the terminal controller 40, or one or more function modules 50. Further, when a display region of the touch screen is touched or actuated (for example, using a user's finger or a touch pen or stylus), the touch screen module 22 can detect a corresponding touch or contact point on the display region of the touch screen, generate an information signal corresponding to the detected touch point, and output the generated information signal to the virtual keyboard providing apparatus 100.

The touch screen module 22 can include various components associated with receiving input through the touch screen and displaying information on the touch screen. For example, the touch screen module 22 can include a display panel for providing a display screen, such as a Liquid Crystal Display (LCD), detection means for detecting an external touch, a signal processing circuit for generating and outputting an information signal corresponding to a detected touch point, and so on.

The virtual keyboard providing apparatus 100 can cause the touch screen module 22 to display various forms of virtual keyboards on the display region of the touch screen by operating in conjunction with the touch screen module 22. Further, the virtual keyboard providing apparatus 100 can receive an information signal, generated when a user touches a virtual keyboard displayed on the display region of the touch screen, from the touch screen module 22 and can send the received information signal to the terminal controller 40.

A given virtual keyboard generated by the virtual keyboard providing apparatus can have a fan shape to take into account the range of motion of a user's fingers or thumb. For example, in the given virtual keyboard, a number of the keys can be arranged in at least a portion of the fan-shaped region, corresponding to a region traversed by the user's thumb, such that the user can easily input information using a finger or the thumb while holding the portable terminal 10 in one hand.

The virtual keyboard providing apparatus 100 can provide a size setting user interface to allow a user to set the size of a virtual keyboard. The size setting user interface can be presented to the user on the display region of the touch screen, and a size of the virtual keyboard can be controlled based on information received from the user through the size setting user interface. The virtual keyboard can be displayed to have a size indicated by the information received through the size setting user interface.

Responsive to a user making a touch or drag action on the display region of the touch screen, the virtual keyboard providing apparatus 100 may select a virtual keyboard, move the position of a virtual keyboard on the display region of the touch screen, or switch the input mode of a virtual keyboard. Different input modes can be provided, each mode allowing the user to input different language characters or special characters, such as the Korean alphabet, the English alphabet, or symbols.

The terminal controller 40 can control each of the function modules 50 in response to the information signal received from the virtual keyboard providing apparatus 100. The function modules 50 can include modules for performing respective unique functions associated with various services, such as text transmission service, multimedia service, game service and wireless Internet service, provided by the portable terminal 10.

Described below are configuration, functions, and operating procedures of the virtual keyboard providing apparatus 100 according to an embodiment of the present disclosure.

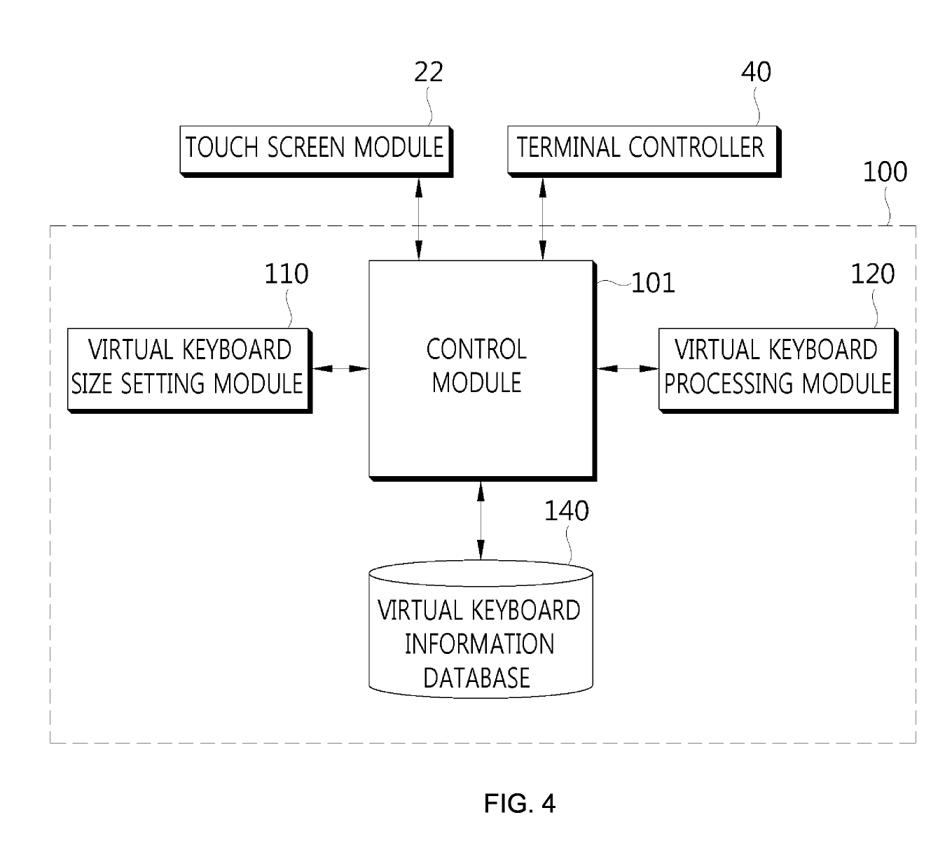

FIG. 4 is a block diagram showing an exemplary configuration of the virtual keyboard providing apparatus 100 according to an embodiment of the present disclosure. The virtual keyboard providing apparatus 100 can include a virtual keyboard information database (DB) 140, a virtual keyboard processing module 120, a virtual keyboard size setting module 110, and a control module 101. The control module 101 can control the interaction and overall data flow between the elements 110, 120, and 140.

The virtual keyboard information DB 140 can store virtual keyboard configuration information for configuring at least one virtual keyboard. The virtual keyboard configuration information can include a position of a virtual keyboard on the display region of the touch screen, a display region of a virtual keyboard, positions of the keys within a virtual keyboard, values assigned to the keys based on an input mode, and graphics information.

For illustrative purposes only, four examples of virtual keyboard configurations are described below. However, the virtual keyboard information DB 140 can store information associated with various number of virtual keyboard configurations. The number of virtual keyboards and the shapes of the virtual keyboards can be modified in various ways. For example, the virtual keyboard information DB 140 can store four different virtual keyboard configuration information, including a first virtual keyboard configuration information, a second virtual keyboard configuration information, a third virtual keyboard configuration information and a fourth virtual keyboard configuration information. The four different configuration information can be used to configure four virtual keyboards, including a first virtual keyboard, a second virtual keyboard, a third virtual keyboard, and a fourth virtual keyboard.

The virtual keyboard processing module 120 can select one of the virtual keyboard configuration information stored in the virtual keyboard information DB 140 in response to a received virtual keyboard request signal. The virtual keyboard processing module 120 can receive the request for virtual keyboard from an entity external to the virtual keyboard providing apparatus, such as user input or the terminal controller 40. The selected virtual keyboard configuration information can be used to configure a corresponding virtual keyboard, and the configured virtual keyboard can be displayed on the display area of the touch screen based on the selected virtual keyboard configuration information.

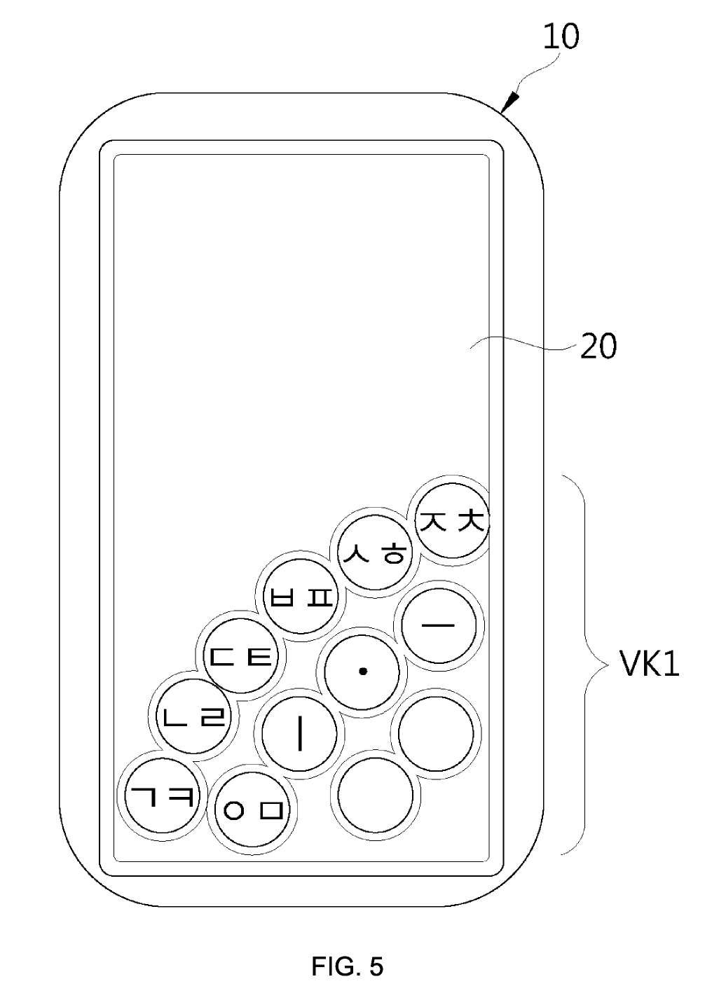

FIG. 5 is a diagram showing a first exemplary virtual keyboard provided by the virtual keyboard providing apparatus 100. The first virtual keyboard VK1 is configured to have a shape in which a number of the keys are arranged within a fan- or arc-shaped display region with a lower right display portion of the touch screen 20 of the portable terminal 10 being a central point of the fan or arc. The first virtual keyboard VK1 enables a right-handed user to easily touch and interface with the keys arranged in the fan- or arc-shaped region using the thumb on his right hand with the portable terminal 10 held in the vertical direction or portrait configuration as shown in FIG. 5. In other words, the first virtual keyboard VK1 is a virtual keyboard corresponding to the fan- or arc-shaped region accessible by the user's thumb on his right hand traversing the display surface of the touch screen 20 in a natural sweeping motion while holding the portable terminal 10 with the right hand).

The virtual keyboard processing module 120 can select the first virtual keyboard configuration information from among the different configurations stored in the virtual keyboard information DB 140. The selected first configuration is used to configure a corresponding first virtual keyboard, and the virtual keyboard processing module 120 send the configured first virtual keyboard to the touch screen module 22 to be displayed on the display region of the touch screen 20 based on the extracted first virtual keyboard configuration information.

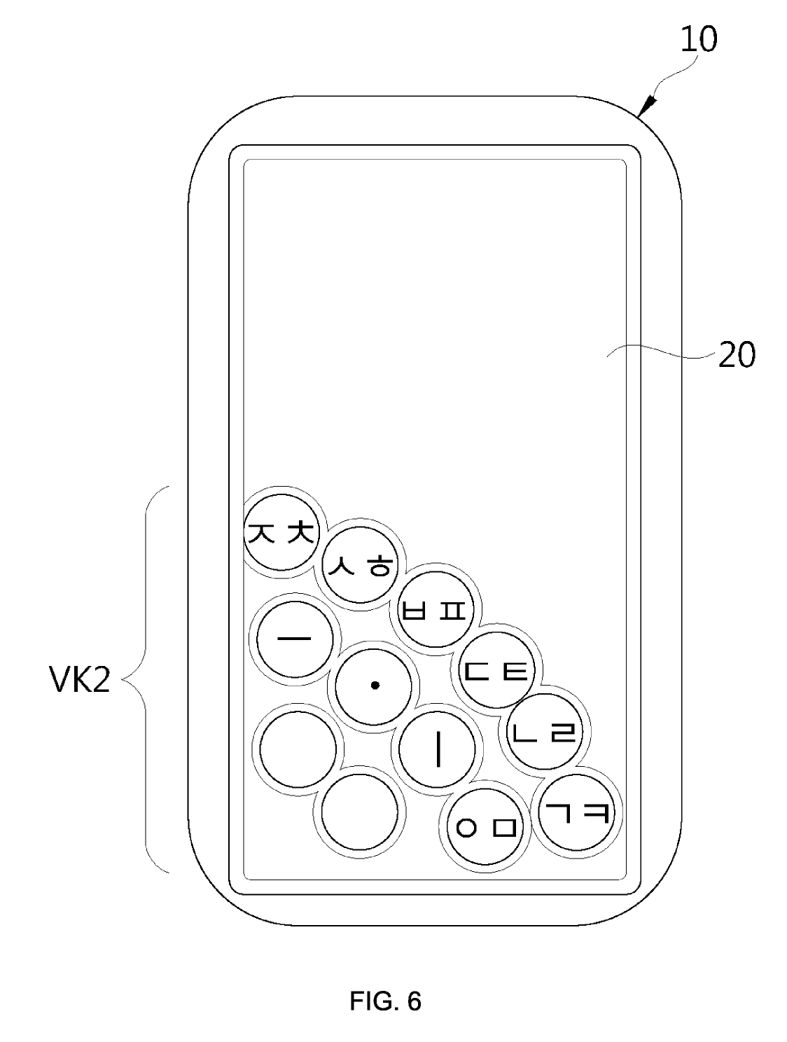

FIG. 6 is an exemplary diagram showing a second virtual keyboard provided by the virtual keyboard providing apparatus 100. The second virtual keyboard VK2 is configured to have a shape in which a number of the keys are arranged within a fan- or arc-shaped display region with a lower left display portion of the touch screen 20 of the portable terminal 10 being a central point. The second virtual keyboard VK2 can allow a left-handed user to easily touch and interface with the keys arranged in the fan- or arc-shaped region using the thumb on his left hand while holding the portable terminal 10 in the vertical direction or in portrait configuration. In other words, the second virtual keyboard VK2 is a virtual keyboard corresponding to the fan- or arc-shaped display region traversed by the user's thumb on the left hand moving in a natural range of motion while holding the portable terminal 10 with the left hand.

The virtual keyboard processing module 120 can select the second virtual keyboard configuration information from among the different configurations stored in the virtual keyboard information DB 140. The selected virtual keyboard configuration is used to configure the corresponding second virtual keyboard, and the virtual keyboard processing module 120 sends the configured second virtual keyboard to the touch screen module 22 to be displayed on the display region of the touch screen 20 based on the extracted second virtual keyboard configuration information.

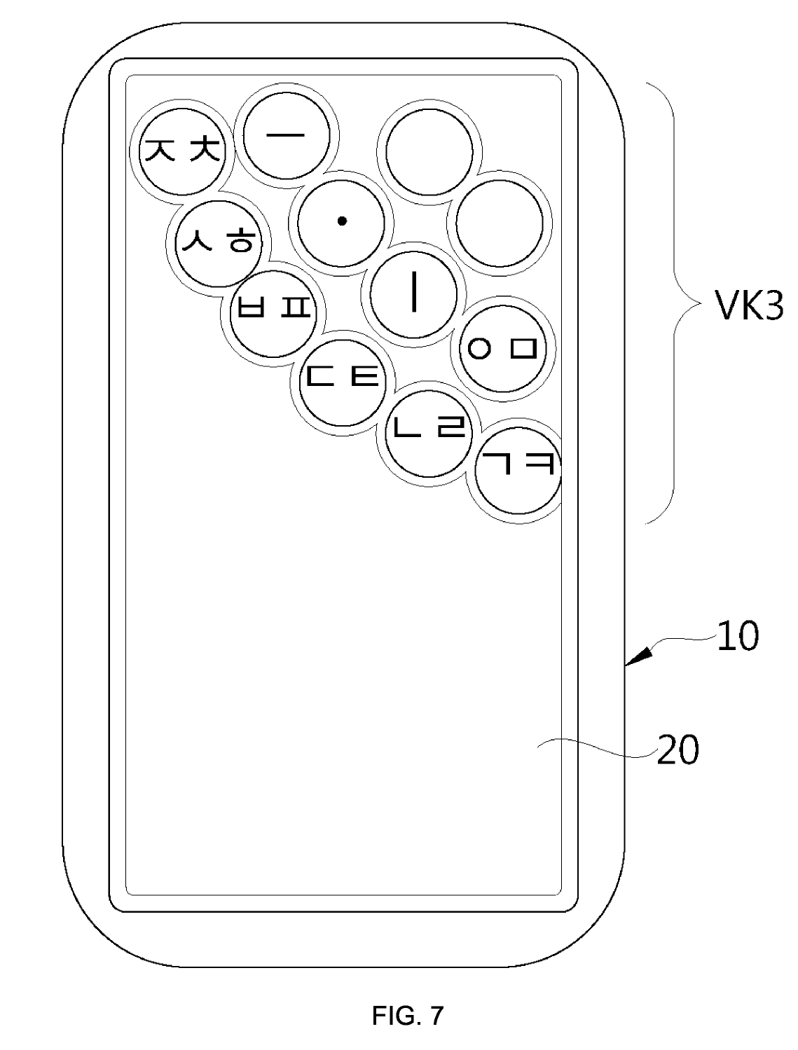

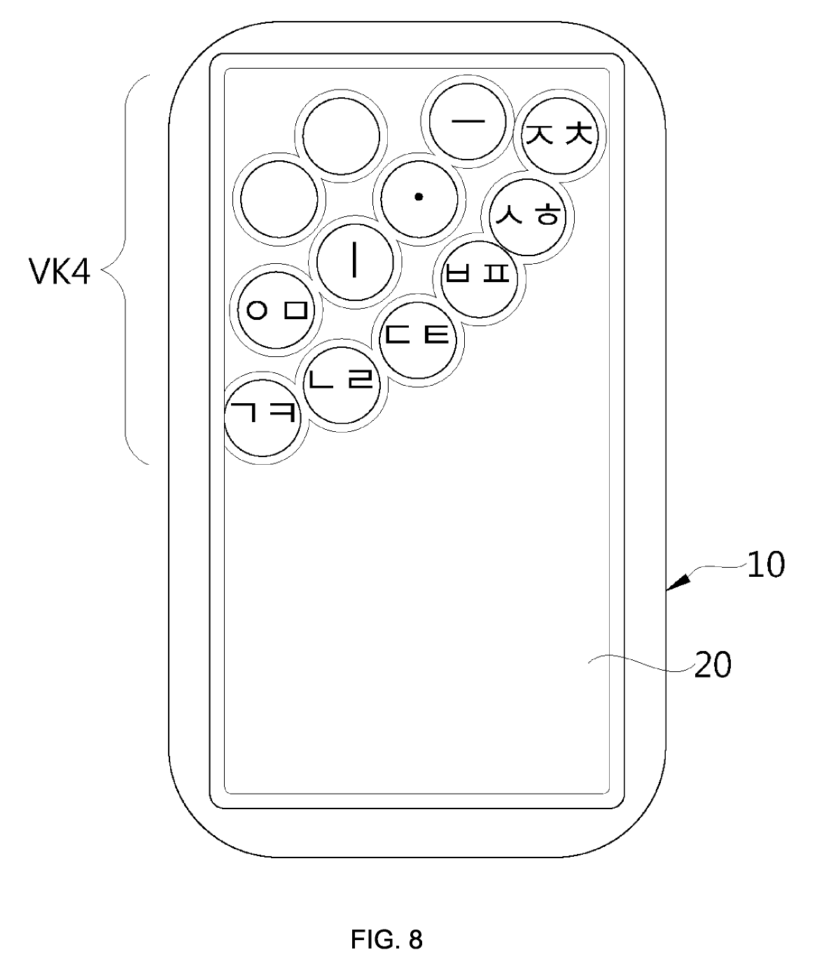

FIGS. 7 and 8 are exemplary diagrams showing a third and a fourth example of a virtual keyboards which are yet another of various types of the virtual keyboards provided by the virtual keyboard providing apparatus 100 according to specific embodiments of the present disclosure. The virtual keyboard providing apparatus 100 can provide yet another virtual keyboard configuration in addition to the first virtual keyboard and the second virtual keyboard configuration described with respect to FIGS. 5-6.

As shown in FIG. 7, for example, a third virtual keyboard VK3 can be configured to have a shape in which a number of the keys are arranged within a fan- or arc-shaped display region with an upper right display portion of the touch screen 20 of the portable terminal 10 being a central point of the fan or arc. The virtual keyboard processing module 120 can select a third virtual keyboard configuration information among the different configuration information stored in the virtual keyboard information DB 140, and use the selected third configuration to configure a corresponding third virtual keyboard. The configured third virtual keyboard is sent to the touch screen module 22 to be displayed on the display region of the touch screen 20 based on the extracted third virtual keyboard configuration information.

As shown in FIG. 8, for example, a fourth virtual keyboard VK4 can be configured to have a shape in which a number of the keys are arranged within a fan- or arc-shaped display region with an upper left display portion of the touch screen 20 of the portable terminal 10 being a central point or the fan or arc. The virtual keyboard processing module 120 can select a fourth virtual keyboard configuration information from among the different configurations stored in the virtual keyboard information DB 140, and use the selected fourth configuration information to configure a corresponding fourth virtual keyboard. The configured fourth virtual keyboard is sent to the touch screen module 22 to be displayed on the display region of the touch screen 20 based on the extracted fourth virtual keyboard configuration information.

When multiple virtual keyboard configuration information corresponding to respective multiple virtual keyboards are stored in the virtual keyboard information DB 140, the virtual keyboard processing module 120 may provide a setting function for setting one of the available virtual keyboards (based on corresponding configuration information) to be displayed first in response to a virtual keyboard request signal.

For example, the virtual keyboard processing module 120 can display a user interface for selecting a virtual keyboard to be displayed first from among the available virtual keyboards (e.g., the first virtual keyboard VK1, the second virtual keyboard VK2, the third virtual keyboard VK3, the fourth virtual keyboard VK4, etc.) on the display region of the touch screen 20. The user interface can allow for use selection based on the needs or characteristics of the user. For example, a right-handed user can select the first virtual keyboard VK1 using the user interface. Responsive to the user selection of the first virtual keyboard VK1, the user interface can set the first virtual keyboard VK1 as a virtual keyboard to be displayed first. Once this has been set, a subsequent request for a virtual keyboard can generate a request signal, which is sent to the virtual keyboard processing module 120. Responsive to the virtual keyboard request signal, the virtual keyboard processing module 120 can select the first virtual keyboard configuration information, corresponding to the first virtual keyboard VK1, from the virtual keyboard information DB 140. The selected configuration information is used to configure the corresponding first virtual keyboard VK1, and the virtual keyboard processing module sends the configured first virtual keyboard VK1 to the touch screen module 22 to be displayed on the display region of the touch screen 20.

Moreover, responsive to a user input, such as a touch or drag action on the display region of the touch screen 20, the virtual keyboard processing module 120 may perform various functions. For example, the virtual keyboard processing module 120 can select a virtual keyboard, move the position of a virtual keyboard, or switch the input mode of a virtual keyboard in response to the corresponding touch or drag action.

The different types of user interactions can be designated as follows. A touch or drag action to select a virtual keyboard can be designated as a ‘virtual keyboard selection action’. A touch or drag action to move the position of a virtual keyboard can be designated to as a ‘virtual keyboard position movement action’. Further, a touch or drag action to switch the input mode of a virtual keyboard can be designated as an ‘input mode selection action.’

Responsive to the virtual keyboard selection action received from the user through touch screen 20, the virtual keyboard processing module 120 can display the selected virtual keyboard on the display region of the touch screen instead of the virtual keyboard currently being displayed. For example, responsive to the user inputting the virtual keyboard selection action, the virtual keyboard processing module 120 receives an information signal indicating the virtual keyboard selection action for selecting another virtual keyboard from the touch screen module 22. Responsive to the received signal, the virtual keyboard processing module 120 can select a virtual keyboard configuration information, corresponding to the selected virtual keyboard, from the virtual keyboard information DB 140 and send information based on the selected virtual keyboard configuration information to the touch screen module 22 so that the selected virtual keyboard can be displayed on the display region of the touch screen 20. The information sent to the touch screen module 22 includes position of the selected virtual keyboard, the display region of the selected virtual keyboard, positions of the keys included in the selected virtual keyboard, etc.

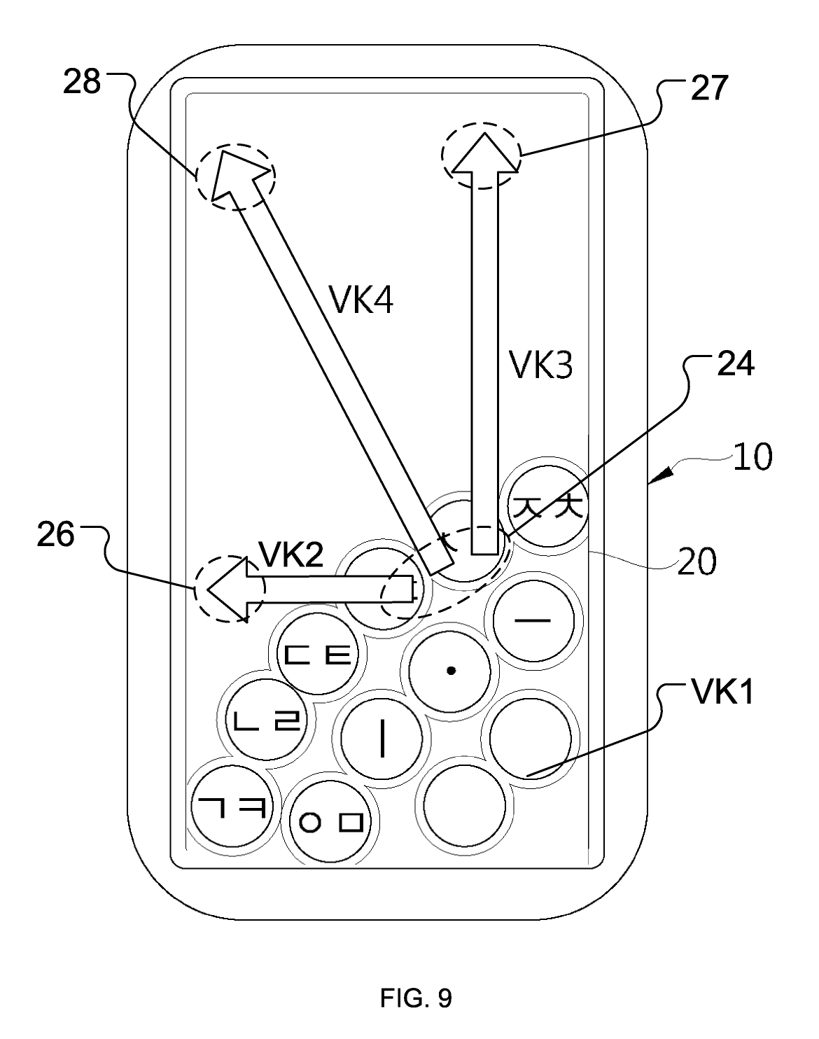

FIG. 9 is a diagram illustrating an exemplary virtual keyboard selection action for selecting different virtual keyboards on the display region of the touch screen 20. Referring to FIGS. 5 to 9, when the first virtual keyboard VK1 is currently being displayed on the display region of the touch screen 20, the user can select the remaining three virtual keyboard using corresponding touch and/or drag motions on the display region of the touch screen. For example, a virtual keyboard selection action for selecting the second virtual keyboard VK2 can include a user action to make a drag action across the display region of the touch screen from a designated start location 24 within the first virtual keyboard VK1 to an end location 26 in which the second virtual keyboard VK2 is normally displayed (see location of VK2 at lower left side as shown in FIG. 6). The arrow labeled VK2 shows the drag motion for selecting the third virtual keyboard.

A virtual keyboard selection action for selecting the third virtual keyboard VK3 can include a user action to touch and drag across the display region of the touch screen 20 starting from a designated start location 24 within the first virtual keyboard VK1 to an end location 27 in which the third virtual keyboard VK3 is normally displayed (see location of VK3 at upper right side as shown in FIG. 7). The arrow labeled VK3 represents the user action for selecting the third virtual keyboard.

Further, a virtual keyboard selection action for selecting the fourth virtual keyboard VK4 can include a user action to touch and drag across the display region of the touch screen 20 from a start location 24 within the first virtual keyboard VK1 to an end location 28 in which the fourth virtual keyboard VK4 is normally displayed (these location of VK4 at upper left side as shown in FIG. 8).

As described above, the virtual keyboard selection action can be an action to drag from a start location within a currently displayed virtual keyboard to an end location on the display region of the touch screen 20 where the selected virtual keyboard will be displayed. Similarly, when the second virtual keyboard VK2 is currently displayed on the display region of the touch screen 20, a user input to touch and drag from a start location within the currently displayed second virtual keyboard VK2 to the right side, the upper right side, and the upper left side of the touch screen 20 can result in the selection of the first virtual keyboard VK1, the third virtual keyboard VK3, and the fourth virtual keyboard VK4 respectively. Such a selection of a virtual keyboard using a drag motion on the display region of the touch screen 20 can be applied in various ways.

Additionally, the user selection of a virtual keyboard can be implemented using other motions, such as consecutively touching, for a predetermined number of times, a designated portion of the display region of the touch screen 20. For example, a user can touch the lower right portion of the display region two consecutive times to select the first virtual keyboard VK1; touch the lower left portion of the display region two consecutive times to select the second virtual keyboard VK2, touch the upper right portion of the display region two consecutive times to select the third virtual keyboard VK3; and touch the upper left portion of the display region two consecutive times to select the fourth virtual keyboard VK4. In some embodiments, such a selection of a virtual keyboard can be implemented by a method of using a dedicated key for selecting the corresponding virtual keyboard.

Also, the virtual keyboard processing module 120 can move the position of a virtual keyboard displayed on the display region of the touch screen 20 in response to a user input that indicates a virtual keyboard position movement action for moving the position of the virtual keyboard.

Responsive to the user input, the virtual keyboard processing module 120 receives, from the touch screen module 22, an information signal indicating the virtual keyboard position movement action for moving a virtual keyboard to a new location. Responsive to the received signal, the virtual keyboard processing module 120 can calculate information about the indicated new location, the positions (for example, coordinate values) of the keys in the virtual keyboard according to the movement, etc. and move the virtual keyboard to the specified new location on the display region of the touch screen 20 based on the calculated information.

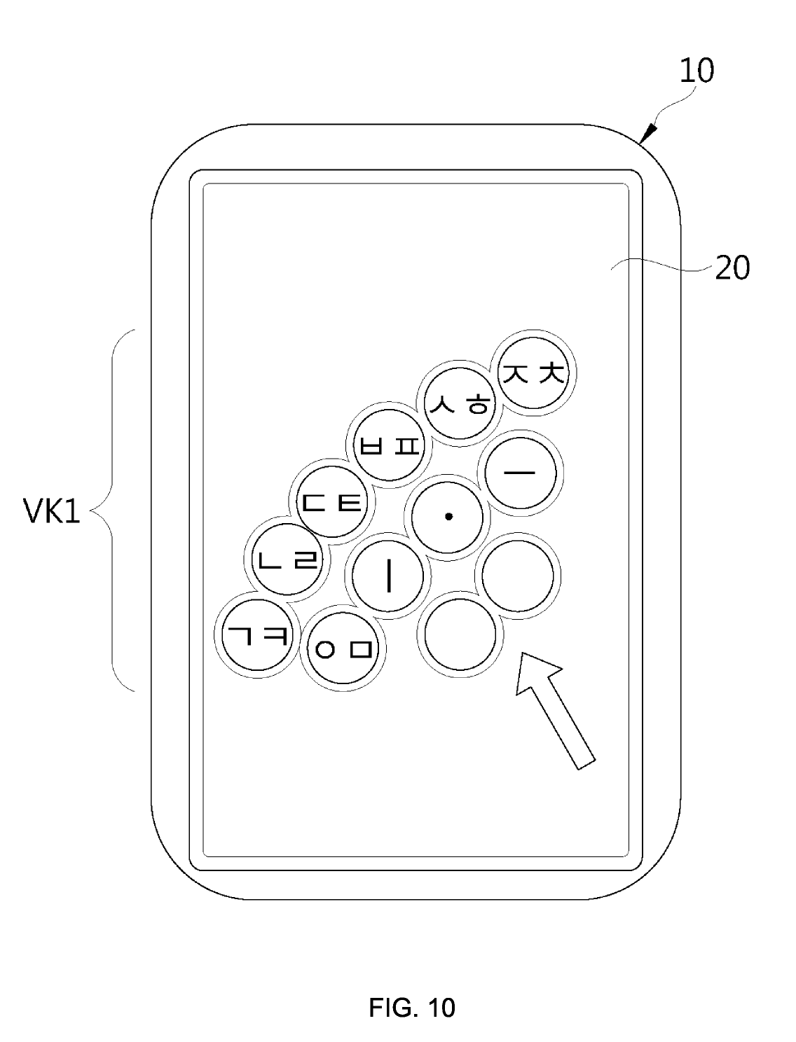

FIG. 10 is a diagram illustrating an exemplary implementation of a virtual keyboard movement action for moving a virtual keyboard. Referring to FIGS. 5 and 10, the first virtual keyboard VK1 is originally displayed on the lower right display portion of the touch screen 20 (see FIG. 5). Responsive to a user action to touch and drag across the display region of the touch screen from a start location within the first virtual keyboard VK1 to a new position, the virtual keyboard processing module 120 can move the first virtual keyboard VK1 to the corresponding new position (see FIG. 10). The arrow indicates the drag motion to move the virtual keyboard to the new location.

The virtual keyboard processing module 120 may analyze and process an information signal, received from the touch screen module 22 responsive to the user action, in real time and display the virtual keyboard to show the indicated movement in real time on the display region of the touch screen 20 while the user is making the drag action. For example, when the first virtual keyboard VK1 is currently displayed on the display region of the touch screen 20, a user action to touch and drag the displayed first virtual keyboard VK1 from a current location to the upper left side of the display region can cause the virtual keyboard processing module 120 to process the received action and display the first virtual keyboard VK1 in motion in real-time based on the drag action. If the user stops the drag action at a specific position, the first virtual keyboard VK1 is likewise stopped at the corresponding position to allow the user to input information using the virtual keyboard displayed at the new location. If the drag action continues further to the upper left side, a display region assigned to the fourth virtual keyboard VK4 is reached. When the new location is reached, the first virtual keyboard VK1 that has moved across the display region in real time can be switched to display the fourth virtual keyboard VK4 on the display region of the touch screen 20.

As described above, the virtual keyboard processing module 120 can analyze and process an information signal, received from the touch screen module 22, in real time and display, on the display region of the touch screen 20, a virtual keyboard that is moved in real time while a drag action is taken. Accordingly, a user can easily move or select a virtual keyboard.

The virtual keyboards shown in FIGS. 5 to 8 illustrate virtual keyboards of a form which can be conveniently used by a user holding a portable terminal in either the left or the right hand in the vertical direction or portrait configuration. However, a virtual keyboard may be configured to have another form which can be conveniently used by a user with the portable terminal held or placed in the horizontal direction or landscape configuration.

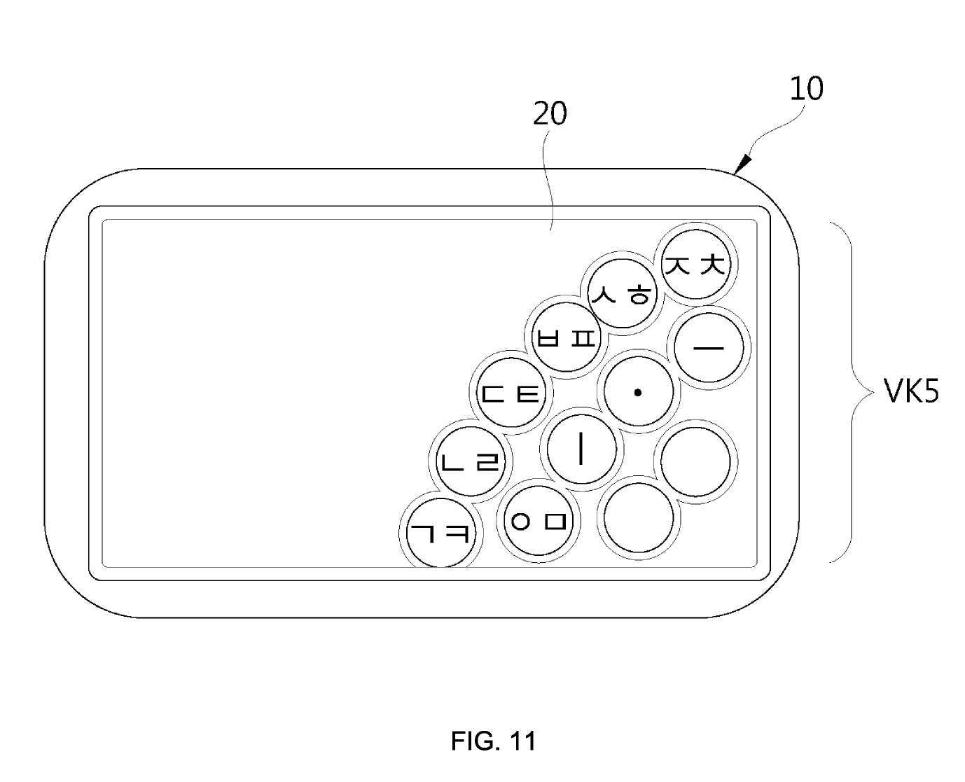

FIG. 11 is a diagram illustrating an example of a virtual keyboard provided by the virtual keyboard providing apparatus 100 to be displayed and used with a portable terminal held in the landscape configuration. The virtual keyboard providing apparatus 100 may provide a virtual keyboard VK5 configured to support a convenient use of the portable terminal 10 in the horizontal direction or landscape configuration. To support both the portrait and landscape configurations, the virtual keyboard configuration information stored in the virtual keyboard information DB 140 can include values corresponding to the respective keys for use in the horizontal direction or landscape configuration and values corresponding to the respective keys for use in the vertical direction or portrait configuration.

The virtual keyboard providing apparatus 100 may provide a horizontal (landscape)/vertical (portrait) selection key such that a user can reconfigure a virtual keyboard for use in the horizontal direction or a virtual keyboard for use in the vertical direction. Also, a specific touch action or a specific drag action can be implemented as a horizontal/vertical selection action. The virtual keyboard processing module 120 can obtain information from the virtual keyboard information DB 140 in response to the horizontal/vertical selection key or the horizontal/vertical selection action and display a corresponding virtual keyboard on the display region of the touch screen 20.

Additionally, the virtual keyboard processing module 120 may switch the input mode of a virtual keyboard, displayed on the display region of the touch screen 20, in response to an input mode switch action for switching the input mode of a virtual keyboard. The input mode can refer to a mode for inputting different languages, (such as the Korean alphabet and English), special characters, numbers, etc. For example, the input mode can include a Korean alphabet input mode, an English input mode, a special character input mode, a numeric input mode or the like.

Responsive to a user action switching the input mode, the virtual keyboard processing module receives, from the touch screen module 22, an information signal indicating the input mode switch action. Responsive to the received signal, the virtual keyboard processing module 120 can extract values, corresponding to the respective keys according to the switched input mode, from the virtual keyboard information DB 140 and display key values according to the switched input mode on the display region of the touch screen 20 based on the extracted values.

Each of the virtual keyboard configuration information stored in the virtual keyboard information DB 140 can include values corresponding to the respective keys for an input mode. For example, each virtual keyboard configuration information can include values corresponding to the respective keys of to the Korean alphabet input mode, values corresponding to the respective keys of the English input mode, values corresponding to the respective keys of the numeric input mode, values corresponding to the respective keys of the special character input mode, and so on.

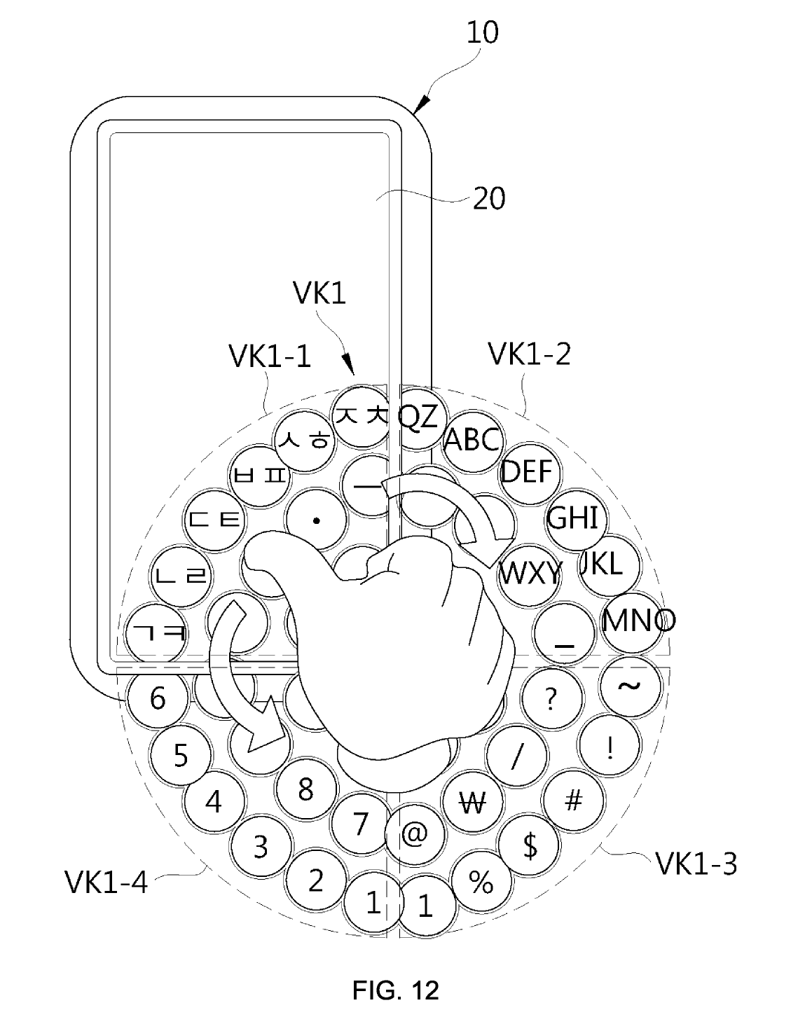

FIG. 12 is a diagram illustrating an example of implementing input mode switch action for switching the input mode of a virtual keyboard. This figure illustrates switching the input mode of the first virtual keyboard VK1 shown in FIG. 5. However, the input mode can be also switched for other virtual keyboards, such as VK2, VK3 and VK4.

As shown in FIG. 12, the input mode switch action for switching the input mode of the first virtual keyboard VK1 can be a user action to make a circular motion in a clockwise or counterclockwise direction starting from a start location within a display region of the first virtual keyboard VK1 which is displayed on the display region of the touch screen 20.

The first virtual keyboard VK1 can be sequentially switched to the numeric input mode VK1-4, the special character input mode VK1-3, the English input mode VK1-2, and the Korean alphabet input mode VK1-1 in response to the circular motion in the clockwise direction. Further, the first virtual keyboard VK1 can be sequentially switched to the English input mode VK1-2, the special character input mode VK1-3, the numeric input mode VK1-4, and the Korean alphabet input mode VK1-1 in response to the circular motion in the counterclockwise direction.

For the switching function described above, the virtual keyboard configuration information can include multiple values for the keys, one for each input mode. For example, the values corresponding to the respective keys for the input modes of the first virtual keyboard configuration information stored in the virtual keyboard information DB 140 can include values corresponding to the respective keys for the Korean alphabet input mode VK1-1, values corresponding to the respective keys according to the English input mode VK1-2, values corresponding to the respective keys according to the special character input mode VK1-3, and values corresponding to the respective keys according to the numeric input mode VK1-4.

Any one of the input modes can be set as the default mode. For example, assuming that the Korean alphabet input mode VK1-1 is set as the default mode, when first displaying the first virtual keyboard VK1 on the display region of the touch screen 20, the virtual keyboard processing module 120 can obtain values corresponding to the respective keys for the Korean alphabet input mode VK1-1 from the first virtual keyboard configuration information and display the obtained values. When the keyboard processing module 120 receives, from the touch screen module 22, an information signal indicating the input mode switch action, the virtual keyboard processing module 120 can obtain values corresponding to the respective keys for a corresponding input mode and send the obtained values to the touch screen module 22 such that the first virtual keyboard VK1 of the switched input mode can be displayed on the display region of the touch screen.

Although the virtual keyboard has been described to be displayed in a fan- or arc-shape on the display region of the touch screen 20, the virtual keyboard can be conceptually said to be a disk-shaped virtual keyboard in which a number of virtual keyboards, each having a fan shape and a unique input mode, are combined together as shown in FIG. 12. In other words, a conceptual virtual keyboard of a disk shape, including a number of input modes, is configured, and any one of the input modes can be displayed in a fan- or arc-shape on the display region of the touch screen 20. The virtual keyboard appears to be a fan- or arc-shape because only a portion of the entire disk is displayed at a given time.

Different users may prefer to display virtual keyboards with different sizes because different users may have different finger or thumb lengths or hold the portable terminal 10 in different ways. Accordingly, the virtual keyboard providing apparatus 100 may provide a function which enables a user to adjust the size of a virtual keyboard. Such a function can be provided by the virtual keyboard size setting module 110.

The virtual keyboard size setting module 110 can provide a size setting user interface for setting the size of a virtual keyboard on the display region of the touch screen 20. Responsive to the user input received through the size setting user interface, the virtual keyboard size setting module 110 can set size information for the corresponding virtual keyboard. Also, the virtual keyboard size setting module 110 can send the set size information to the virtual keyboard processing module 120.

The virtual keyboard size setting module 110 can receive coordinate information about a specific point or information about a specific region through the size setting user interface. The virtual keyboard size setting module 110 can set size information about a virtual keyboard based on the coordinate information about the specific point or the information about the specific region.

Also, the size setting user interface may be used to receive selection information about the type of a virtual keyboard whose size will be adjusted (for example, information about whether a virtual keyboard whose size will be adjusted is a first keyboard or a second keyboard). When determining the size information, the virtual keyboard size setting module 110 can take the received selection information for the virtual keyboard into consideration.

Hereinafter, an implementation is described for the virtual keyboard providing apparatus 100 to set the size of a virtual keyboard and display the virtual keyboard having the set size on the display region of the touch screen 20.

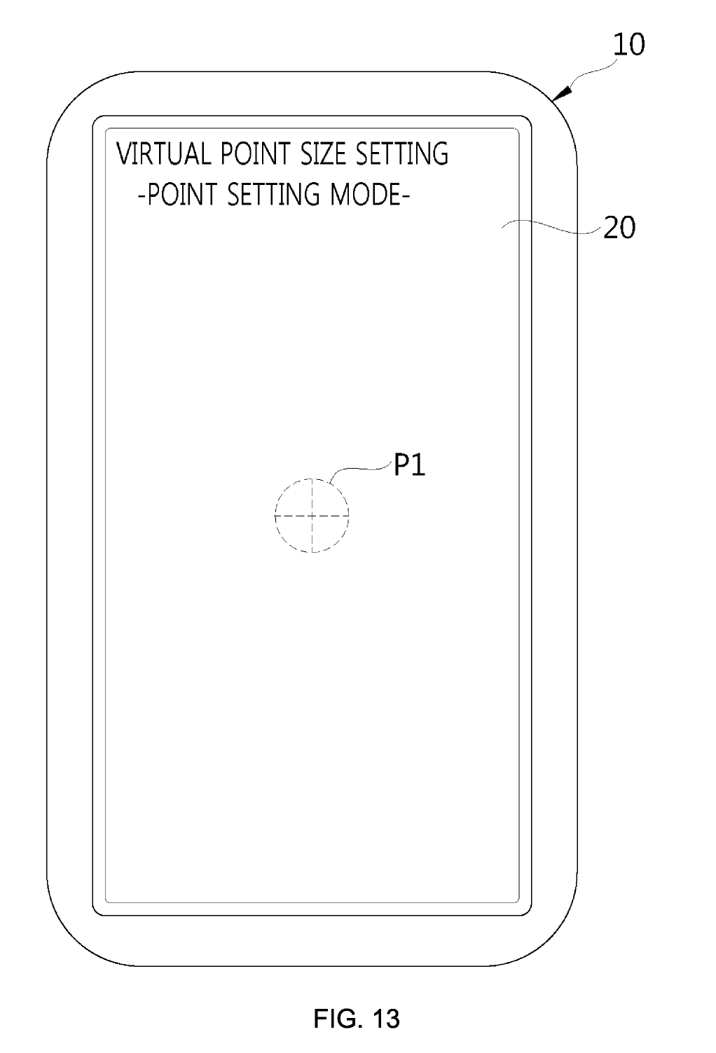

FIG. 13 is a diagram showing an exemplary implementation of a size setting user interface displayed on the display region of the touch screen 20 by the virtual keyboard size setting module 110. As shown in FIG. 13, a size setting user interface can be displayed on the display region of the touch screen to instruct the user to touch a specific point on the display region of the touch screen while holding the portable terminal 10 in one hand. Although not shown, the size setting user interface can be used to instruct a user to select the type of a virtual keyboard whose size will be adjusted through the size setting user interface. For illustrative purposes, the following description is provided after a user has selected the first virtual keyboard VK1 which is suitable for a right-handed person.

When the user touches a specific point (for example, P1), the virtual keyboard size setting module 110 sets the size of the first virtual keyboard VK1 based on the coordinate of the specific point P1. For example, the virtual keyboard size setting module 110 can set the display region of a fan- or arc-shaped virtual keyboard, having a radius from a central point to the coordinates of point P1, as the size of the virtual keyboard VK1. The virtual keyboard size setting module 110 can send the set size information to the virtual keyboard processing module 120.

Responsive to the received size information, the virtual keyboard processing module 120 can select the first virtual keyboard configuration information for configuring the first virtual keyboard VK1 from the virtual keyboard information DB 140 and modify the first virtual keyboard configuration information based on the size information received from the virtual keyboard size setting module 110. For example, the virtual keyboard processing module 120 can modify the region information of the first virtual keyboard VK1 based on the size information, calculate positions of the keys within the first virtual keyboard VK1 based on the modified region information, and modify the positions of the keys based on the calculated positions of the keys. The virtual keyboard having modified size can be displayed on the display region of the touch screen 20 based on the modified information.

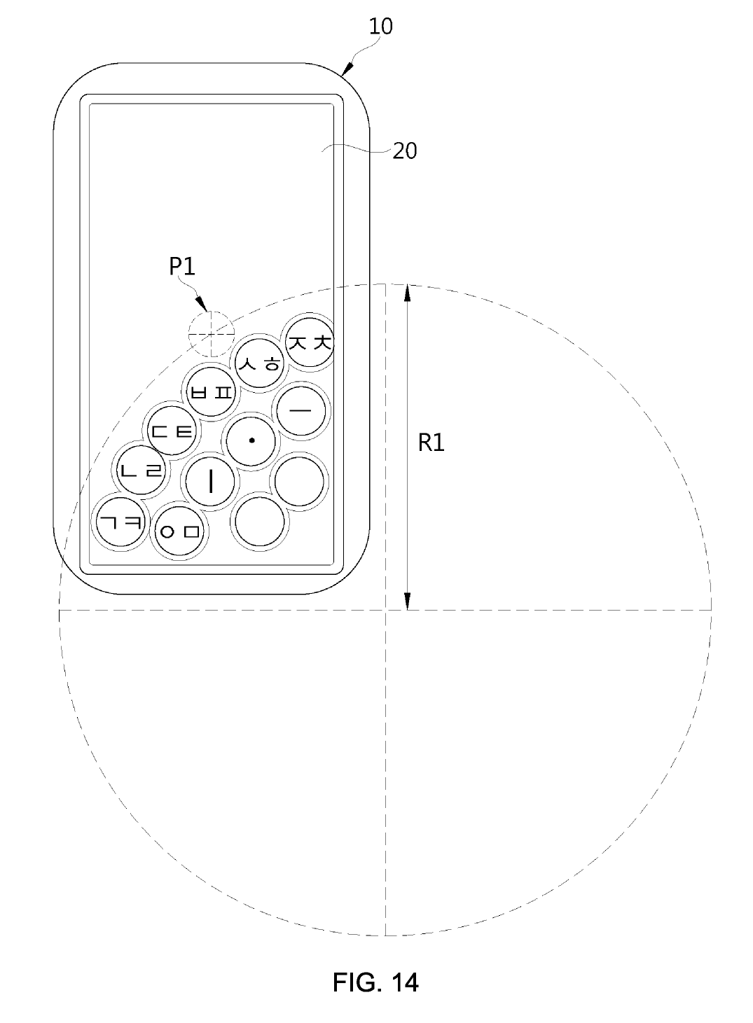

FIG. 14 is a diagram showing an exemplary implementation of a virtual keyboard having a size adjusted by the virtual keyboard processing module 120. As shown in FIG. 14, the virtual keyboard having a shape similar to the first virtual keyboard VK1 is displayed within a fan-shaped display region having a radius R1 from a point P1 to a central point. The point P1 is received from a user through the size setting user interface.

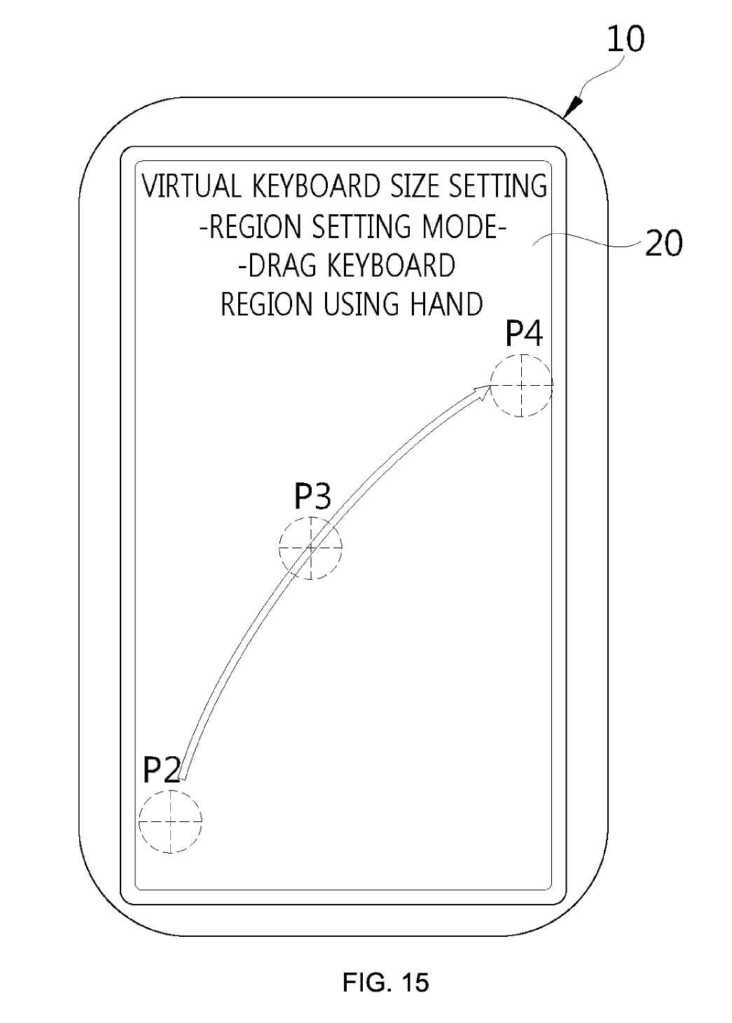

FIG. 15 is a diagram showing another implementation of a size setting user interface displayed on a display region of the touch screen 20.

As shown in FIG. 15, a user interface can be presented to instruct a user to select a desired region within the display region of the touch screen 20 by making a drag action through the size setting user interface. Further, as described above, a user may be instructed to select the type of a virtual keyboard whose size will be adjusted through the size setting user interface. For illustrative purposes only, the following descriptions are provided after a user has selected the first virtual keyboard VK1 which is suitable for a right-handed person. However, the same techniques apply when the user selects any of the other virtual keyboards.

When the user selects a desired display region by dragging from, for example, a point P2 to a point P4 via a point P3, the virtual keyboard size setting module 110 sets the size of the first virtual keyboard VK1 on the basis of the dragged line and sends the set size information to the virtual keyboard processing module 120. The virtual keyboard processing module 120 can select the first virtual keyboard configuration information for configuring the first virtual keyboard VK1 from the virtual keyboard information DB 140, modify the first virtual keyboard configuration information based on the set size information, and display a virtual keyboard coinciding with the region selected by the user.

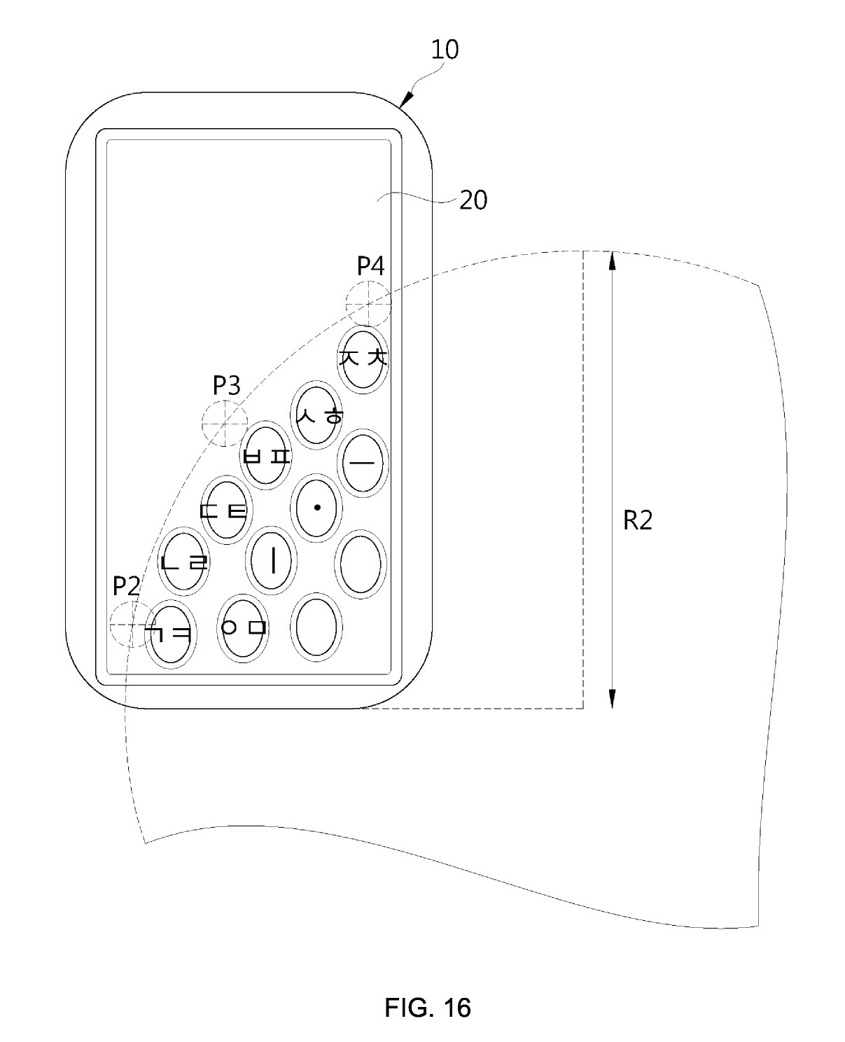

FIG. 16 is a diagram showing an example of a virtual keyboard having a size adjusted by the virtual keyboard processing module 120. As shown in FIG. 16, the virtual keyboard having a size adjusted and having a shape similar to the first virtual keyboard VK1 is displayed within the display region selected through the size setting user interface (that is, a fan-shaped region within the line dragged across P2, P3 and P4 by the user). FIG. 16 shows that the virtual keyboard having a size adjusted is part of a fan shape, having a radius R2 greater than a radius of the original first virtual keyboard VK1. Also, the display region of the virtual keyboard and the ratio of a width and length of each key have been modified based on the set size information.

In addition, the virtual keyboard processing module 120 may store, in the virtual keyboard information DB 140, configuration information for the virtual keyboard having an adjusted size. For example, the virtual keyboard processing module 120 can set the virtual keyboard having an adjusted size as a sixth virtual keyboard and store the configuration information for the sixth virtual keyboard in the virtual keyboard information DB 140. Upon request from a user, the virtual keyboard processing module 120 can select and retrieve the stored configuration information for the sixth virtual keyboard from the virtual keyboard information DB 140 and display the sixth virtual keyboard on the display region of the touch screen 20.

As described above, the virtual keyboard providing apparatus 100 according to the embodiments of the present disclosure can provide a user with a virtual keyboard which can be easily used by the user. When a user makes a simple action (for example, a touch or a drag) on the display region of the touch screen 20, the virtual keyboard providing apparatus 100 allows the user to simply select or switch the shape, the position, the input mode, etc. of a virtual keyboard. Further, the virtual keyboard providing apparatus 100 can provide a virtual keyboard customized for a user because the user can set the size of the virtual keyboard according to his taste (e.g., based on size of his hand and the way he holds the portable terminal).

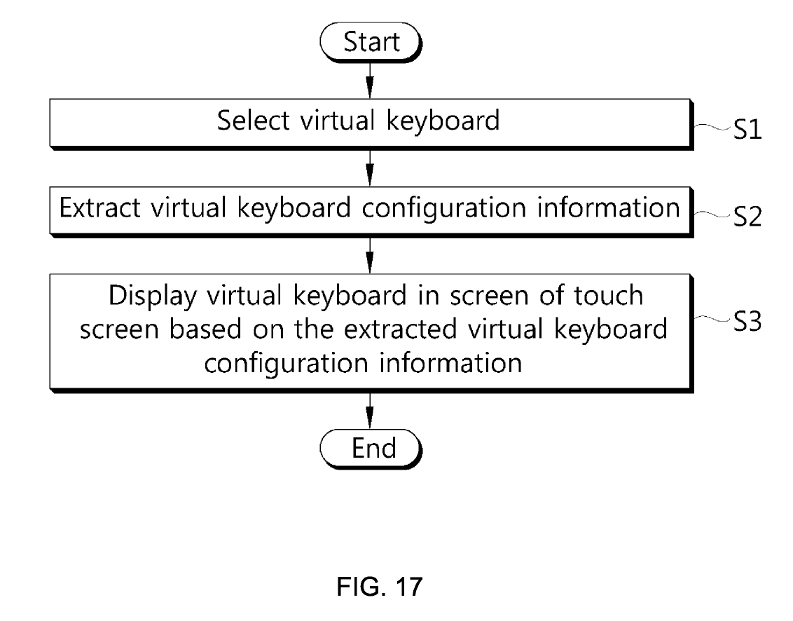

A method of providing a virtual keyboard using the virtual keyboard providing apparatus 100 is described below. FIG. 17 is a flowchart illustrating a procedure of providing a virtual keyboard, which is performed by the virtual keyboard providing apparatus 100. As shown in FIG. 17, the virtual keyboard providing apparatus 100 displays, on the display region of the touch screen 20, a user interface for setting a virtual keyboard to be displayed and selects a virtual keyboard based on information received through the user interface at step S1. For example, assuming that a number of the virtual keyboards can be provided by the virtual keyboard providing apparatus 100, a user can be instructed to select a desired one of the virtual keyboards through the user interface, and the virtual keyboard providing apparatus 100 can select a virtual keyboard based on information received through the user interface. In some embodiments, when a given virtual keyboard is set as a default virtual keyboard or when a given virtual keyboard is previously set, the step S1 can be omitted.

The virtual keyboard providing apparatus 100 selects virtual keyboard configuration information, corresponding to the selected virtual keyboard, from the virtual keyboard information DB 140 at step S2 and displays the virtual keyboard on the display region of the touch screen 20 based on the selected virtual keyboard configuration information at step S3. Here, the displayed virtual keyboard can be a virtual keyboard in which a number of the keys are arranged in at least a portion of a fan-shaped display region. Accordingly, a user can easily input any desired information using a finger, a thumb, a stylus, etc. with the portable terminal 10 held in one hand.

When the user makes a specific touch action or a specific drag action on the display region of the touch screen 20, the virtual keyboard providing apparatus 100 can select a virtual keyboard, move the position of a virtual keyboard, or switch the input mode of a virtual keyboard in response to the corresponding touch or drag action. Such various functions have been described above in detail with reference to FIGS. 9, 10, and 12.

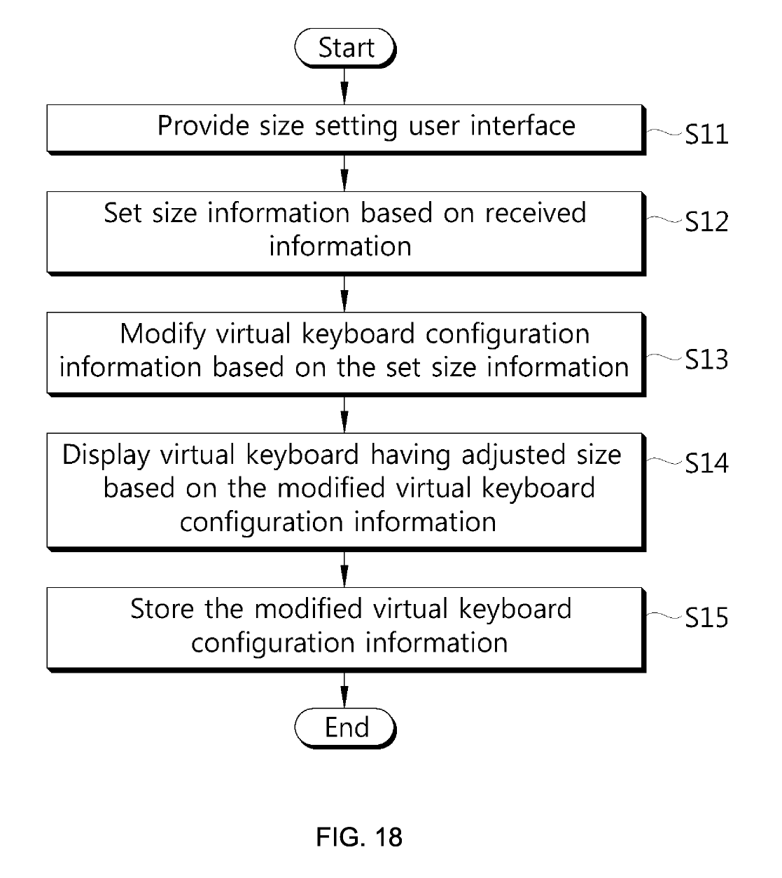

FIG. 18 is a flowchart illustrating a procedure of adjusting the size of a virtual keyboard, which is performed by the virtual keyboard providing apparatus 100. As shown in FIG. 18, the virtual keyboard providing apparatus 100 can display, on the display region of the touch screen 20, a size setting user interface for setting the size of a virtual keyboard at step S11. Here, the size setting user interface can display information, instruct a user to select a specific point or a specific region. Using the user interface, the user can select a specific point or a specific display region by making a touch action or a drag action on the display region of the touch screen 20.

Further, the size setting user interface may display information instructing a user to select a virtual keyboard whose size will be adjusted. In this case, the user may select the virtual keyboard whose size will be adjusted.

The virtual keyboard providing apparatus 100 can set the size of the virtual keyboard based on the information (for example, information about the specific point or the specific display region) received through the size setting user interface at step S12. When the virtual keyboard is selected using the size setting user interface, the virtual keyboard providing apparatus 100 can take into consideration a type of the selected virtual keyboard when setting the size.

The virtual keyboard providing apparatus 100 selects the virtual keyboard configuration information for the virtual keyboard from the virtual keyboard information DB 140 and modifies the virtual keyboard configuration information based on the set size at step S13. For example, the virtual keyboard providing apparatus 100 can modify the display region of the virtual keyboard based on the set size, calculate the positions of the keys within the virtual keyboard based on the modified display region, and modify the positions of the keys according to the calculated positions.

The virtual keyboard providing apparatus 100 can display, on the display region of the touch screen 20, the virtual keyboard having a size adjusted according to the set size based on the modified virtual keyboard configuration information at step S14. The virtual keyboard providing apparatus 100 can store the modified virtual keyboard configuration information in the virtual keyboard information DB 140 at step S15.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments.

Only a few implementations and examples are described and other implementations, enhancements and variations can be made based on what is described and illustrated in this application.

What is claimed is:

1. An apparatus for providing a virtual keyboard to be displayed on a touch screen, the apparatus comprising:
a memory unit comprising a data repository to store data comprising at least one virtual keyboard configuration information to configure at least one corresponding virtual keyboard; and
a processing module to
select from the data stored in the data repository a given virtual keyboard configuration information to select a corresponding virtual keyboard to configure,
configure the selected virtual keyboard to have a fan-like shape with multiple keys of the virtual keyboard arranged along an outline of an arc in a fan-shaped region based on the selected virtual keyboard configuration information, and
instruct a touch screen module to display the configured virtual keyboard on a display region of a touch screen.

2. The apparatus of claim 1, wherein the at least one virtual keyboard configuration information comprises an indication of at least the following:
a position of the selected virtual keyboard on a display region of the touch screen;
a portion of the display region of the touch screen occupied by the selected virtual keyboard;
positions of the keys within the selected virtual keyboard; and
values associated with the keys, wherein the values are assigned based on an input mode.

3. The apparatus of claim 1, wherein the at least one virtual keyboard comprises at least one of:
a first virtual keyboard in which multiple keys are arranged along an outline of an arc in a fan-shaped region with a lower right portion of the display region of the touch screen being a central point of the arc;
a second virtual keyboard in which multiple keys are arranged along an outline of an arc in a fan-shaped region with a lower left portion of the display region of the touch screen being a central point of the arc;
a third virtual keyboard in which multiple keys are arranged along an outline of an arc in a fan-shaped region with an upper right portion of the display region of the touch screen being a central point of the arc; or
a fourth virtual keyboard in which multiple keys are arranged along an outline of an arc in a fan-shaped region with an upper left portion of the display region of the touch screen being a central point of the arc.

4. The apparatus of claim 1, wherein responsive to receiving, from the touch screen module, a signal indicating a user input for selecting another virtual keyboard, the virtual keyboard processing module selects from the data stored in the data repository another virtual keyboard configuration information to select another virtual keyboard to configure and instructs the touch screen module to display the selected other virtual keyboard on the display region of the touch screen based on the selected other virtual keyboard configuration information.

5. The apparatus of claim 1, wherein responsive to receiving, from the touch screen module, a signal indicating a user input to move the selected virtual keyboard to a different position on the display region of the touch screen, the virtual keyboard processing module is operable to move the selected virtual keyboard to the different position corresponding to the user input.

6. The apparatus of claim 5, wherein the virtual keyboard processing module is operable to, in real time:
analyze and process the signal indicating user input to move the selected virtual keyboard to a different position on the display region of the touch screen, and
instruct the touch screen module to display in real time the selected virtual keyboard moving on the display region of the touch screen during the user input.

7. The apparatus of claim 1, wherein responsive to receiving, from the touch screen, a signal indicating a user input for switching an input mode, the virtual keyboard processing module is operable to switch a given input mode to another input mode based on the received signal indicating the user input for switching the input mode.

8. The apparatus of claim 1, further comprising a virtual keyboard size setting module operable to
provide a user interface for setting a size of the selected virtual keyboard through the display region of the touch screen, and
set a size of the selected virtual keyboard based on information received through the user interface.

9. The apparatus of claim 8, wherein the virtual keyboard size setting module receives coordinates of a point on the display region of the touch screen selected by a user through the user interface.

10. The apparatus of claim 9, wherein the virtual keyboard size setting module sets the fan-shaped region of the selected virtual keyboard having a radius from a central point of the selected virtual keyboard to the received coordinates of the point as the size information.

11. The apparatus of claim 8, wherein the virtual keyboard processing module is operable to instruct the touch screen module to display the user interface to include information instructing the user to make a dragging motion across a desired region on the display region of the touch screen.

12. The apparatus of claim 8, wherein the virtual keyboard processing module is operable to
receive the size information from the virtual keyboard size setting module,
modify the selected virtual keyboard configuration information based on the received size information, and
instruct the touch screen module to display the selected virtual keyboard having a size adjusted based on the modified virtual keyboard configuration information on the display region of the touch screen.

13. The apparatus of claim 12, wherein the virtual keyboard processing module is operable to
modify the portion of the display region of the touch screen occupied by the selected virtual keyboard based on the received size information,
calculate new positions of the keys based on the modified portion of the display region of the touch screen occupied by the selected virtual keyboard, and
modify the positions of the keys based on the calculated new positions of the keys.

14. A method of providing a virtual keyboard performed by a virtual keyboard providing apparatus operating in conjunction with a touch screen module, the method comprising:
selecting a virtual keyboard configuration information to select a corresponding virtual keyboard from data stored in a data repository of a memory unit; and
instructing the touch screen module to display the selected virtual keyboard having a fan-shape in which multiple keys are arranged along an outline of an arc in a fan-shaped region based on the selected virtual keyboard configuration information.

15. The method of claim 14, further comprising:
receiving, from the touch screen module, a signal indicating a user input on the display region of the touch screen for selecting another virtual keyboard;
selecting, from the touch screen module, another virtual keyboard configuration information for configuring another virtual keyboard from the database; and
instructing the touch screen module to display the other virtual keyboard on the display region of the touch screen based on the selected another virtual keyboard configuration information.

16. The method of claim 14, further comprising:
receiving, from the touch screen module, a signal indicative of a user input; and
moving the selected virtual keyboard to a different position corresponding to the user input on the display region of the touch screen.

17. The method of claim 14, further comprising:
receiving a signal indicative of a user action for switching an input mode from the touch screen module; and
switching a given input mode to another input mode corresponding to the received information signal.

18. The method of claim 14, further comprising:
providing a user interface for setting a size of the virtual keyboard on the display region of the touch screen; and
setting a size of the selected virtual keyboard based on information received through the user interface.

19. The method of claim 18, further comprising:
modifying the selected virtual keyboard configuration information based on the set size information; and
displaying the selected virtual keyboard having a size adjusted based on the modified virtual keyboard configuration information on the display region of the touch screen.

20. The method of claim 19, wherein modifying the virtual keyboard configuration information based on the set size information comprises:
modifying the portion of the display region of the touch screen occupied by the virtual keyboard based on the set size information;
calculating positions of the keys based on the modified portion of the display region of the touch screen; and
modifying the positions of the keys based on the calculated positions.
